(19) United States
(12) Patent Application Publication
(10) Pub. No.: US 2011/0062001 A1
(43) Pub. Date: Mar. 17, 2011

(54) Conveyor belt with guide means for curvilinear routes and modules for it

(76) Inventors: Carlo Garbagnati, Lecco (IT); Norberto Cattaneo, Milano (IT)

(21) Appl. No.: 12/735,913

(22) PCT Filed: Feb. 23, 2009
(86) PCT No.: PCT/IB2009/000335

§ 371 Date: Nov. 16, 2010

(30) Foreign Application Priority Data
Feb. 29, 2008 (IT) MI2008A 000345

(51) Int. Cl. B65G 17/08

(52) U.S. Cl. 198/851

(57) ABSTRACT

A curvilinear conveyor belt (10) comprises modules coupled together so as to be hinged through pins (16). At least some modules are equipped with guide means (19) that project below near to a side edge of the belt to interact with guide elements present in a surface on which the belt is intended to nm. The guide means comprise a first element (20) that terminates with an end bent into an L towards the side edge of the module to make an anti-turnover element of the belt, and a second element (23, 123) that projects from the bottom surface of the module in a more inner position than the first element to make, with a side surface thereof, an element for reducing the lateral slipping of the module.

The present invention refers to a modular conveyor belt and, in particular, to a modular conveyor belt for curvilinear routes. The invention also refers to modules for making conveyor belts.

In the field conveyor belts and modules for them are well known that allow curvilinear routes to be travelled. Belts that deal with bends must be equipped with guide means that avoid the turning over that would otherwise be caused by the pulling of the conveyer that deals with the bend and that tends to lift the edge of the belt on the outside of the bend. Belts also need guide means that avoid the belt slipping, in other words drifting sideways with respect to the correct path. Such means are biased to a great extent above all during bends, particularly if it has a tight radius, due to the pull that produces a strong radial component. Often the configuration of the guide means of the prior art that satisfies the rectilinear guiding of the belt is disadvantageous in bends or vice-versa.

The general purpose of the present invention is to provide innovative curvilinear conveyor belts and modules for them, which are strong and have satisfactory characteristics, with particularly simple and effective guide means both travelling in a straight line and round bends, even particularly tight bends.

In view of such a purpose it has been thought of, according to the invention, to make a modular conveyor belt formed from modules that each comprise a body equipped on the front and rear sides with hinging fingers spaced apart to define empty spaces between them that receive hinging fingers of successive modules of the belt, the fingers being equipped with slots for the passage of pins transversal to the conveying direction to coupled together the successive modules so that they are hinged, guide means projecting from a bottom surface of the belt and near to its side edge and intended to interact with guide elements present in a surface on which the belt is intended to run, characterized in that the guide means comprise a first anti-turnover element projecting from the bottom surface of the belt and intended to provide a holding component pointing substantially perpendicular to the plane of the belt and that opposes the turning over of the belt round bends and a second anti-slip element projecting from the bottom surface of the belt in a more inner position than the first element and intended to provide a holding component pointing substantially parallel to the plane of the belt and that stops the belt from slipping sideways.

In order to clarify the explanation of the innovative principles of the present invention and its advantages compared to the prior art hereafter we shall, with the help of the attached drawings, describe a possible example embodiment applying such principles. In the drawings:

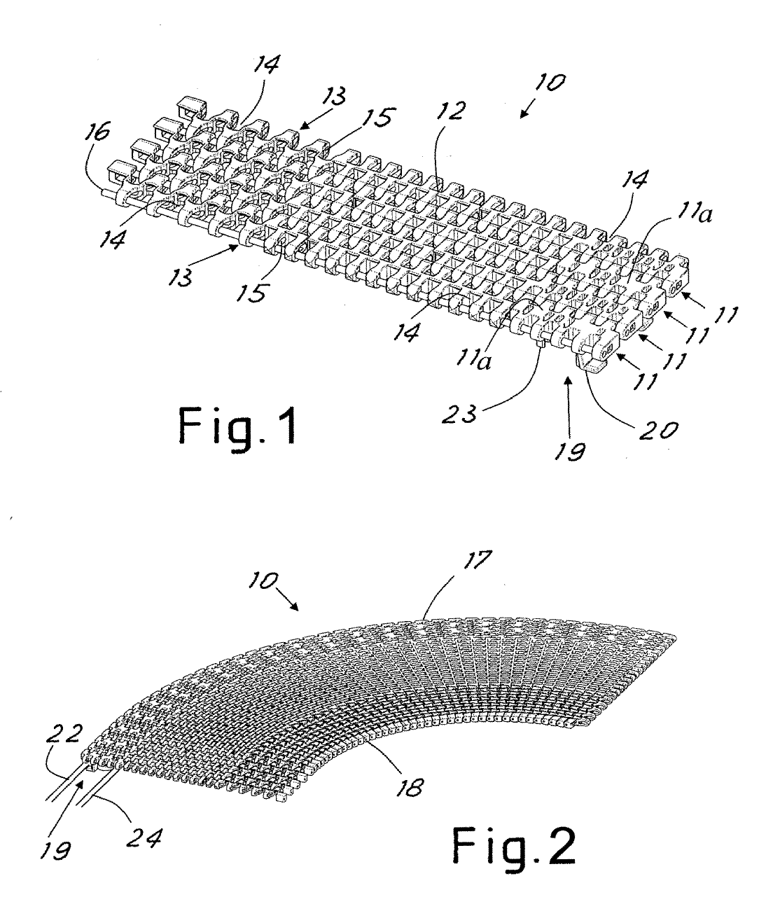

FIG. 1 represents a perspective view of a portion of modular belt according to the invention;

FIG. 2 represents a partial view round a bend of a belt according to the invention;

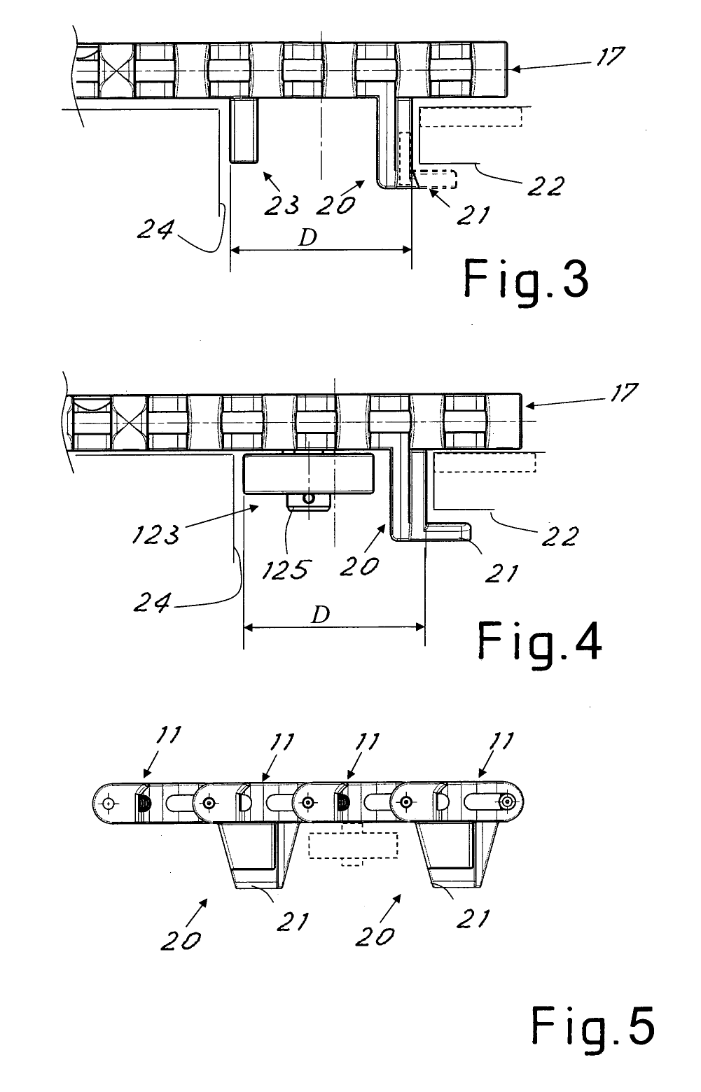

FIGS. 3 and 4 represent top front views of two variants of guide means of the belt along its transportation route;

FIG. 5 represents a top side view of a side end of the belt equipped with the guide means.

With reference to the figures, FIG. 1 shows a portion of conveyor belt 10 made with modules 11 (advantageously molded from suitable plastic material) according to the invention. Each module 11 comprises a body 12 with front and rear sides (referring to the conveying direction) that extend transversally to the conveying direction and on which hinging fingers 13 project, spaced apart to define empty spaces 14 between them. The spaces receive hinging fingers 13 of successive similar modules. For this purpose, the fingers on one side of a module are staggered with respect to the fingers on the opposite side.

The fingers are equipped with slots 15 for the passage of pins 16 transversal to the conveying direction and that couple together the successive modules so that they are hinged.

At least the slots on one side of the module are advantageously stretch in the conveying direction to allow the belt to curve in the transportation plane.

The pitch of the fingers can increase at least by areas from a first side edge 17 towards the opposite side edge 18 of each module. Moreover, advantageously, the length (considered in the conveying direction) of the spaces between the fingers can also increase at least by areas from the first side edge 17 towards the opposite side edge 18 of each module. In this way, in bends towards the edges 18, the fingers 13 most towards the inside of the curve can penetrate farther into the respective spaces and make tighter bends. Advantageously, as can be seen in FIG. 1, the increase in length leads to the spaces extending beyond the middle of the modules towards the opposite rear or front side.

The behavior of such a belt is different in the bends in the opposite direction, but this is not a disadvantage since often conveyor belts are required with tight bends in just one direction. However, in the case in which tight bends are required in both directions, another module structure can be designed by the man skilled in the art. The body of the module thins out from the edge 17 to the edge 18, but this is not a disadvantage since the greatest stresses occur on the outside of a bend. The amount of material used is therefore optimized.

As can be clearly seen in FIG. 1, to further reduce the bending radius the spaces of the area closest to the inside of the bend can have a length such that the fingers penetrate into the base on the opposite side of the module. In such an area, the spaces advantageously extend beyond the middle line of the modules. To allow this, the base of such fingers is wider than the top ends of the fingers and the corresponding spaces have a matching shape with a narrower base and a wider passage area for the pin. The body of the module in such an area becomes configured with short portions in the direction of travel and acquires a repeated S-shaped undulating configuration.

In order to also satisfy requirement to guide the belt, some of the modules advantageously comprise guide means 19 that project from a bottom surface of the belt and near to the side edge that is intended to be farther to the outside in the bends. In the embodiment shown, such an edge is the edge 17. As shown schematically in FIG. 2 the guide means interact with suitable elements 22, 24 of the surface on which the belt runs.

As can be seen in FIG. 3, the guide means comprise a first element 20 projecting from the bottom surface of the module and equipped with means 21 for preventing turning over that produce a component pointing perpendicular to the transportation plane of the belt and that opposes the lifting of the edge of the belt during bends. In order to generate such a resistant component, the means 21 are intended to interact with a fixed or guide element on which the belt runs. For example, FIG. 3 advantageously shows the end of the element 20 projecting towards the periphery of the belt to interfere with an edge element 22 of the running plane of the belt. The projecting part can also extend with an end bent into an L towards the side edge 16 of the module, as shown with a dashed line. The force that opposes turning over can also be magnetic, by providing the element 20 with a suitable magnet (broken line in FIG. 3) that attracts special ferromagnets on the fixed element 22. Magnet and ferromagnetic element can of course exchange places.

The guide means also comprise a second element 23 that projects from the bottom surface of the module in a more inner position than the first element and intended to produce a holding component parallel to the transportation plane, interfacing with a guide surface in the running plane of the belt. In particular, such a second element, with a side surface thereof, makes an element for reducing the slipping sideways of the module resting against the side surface 24 of the other suitable side containment element present in the sliding surface of the belt. Advantageously, the distance D between the most outer vertical surfaces of the elements 20 and 23 can be standard for the rectilinear guide channels of the conveyor belts. For example, D can be equal to 42 mm.

In the portions of rectilinear route there is no turnover torque to counteract and the support element 22 can even be of reduced thickness, as shown with a broken line in FIG. 4. During rectilinear movement, the two guide elements 20 and 23 with their opposite side surfaces make a guide against the slipping sideways of the belt in both directions. In particular, the side surface of the first element facing towards the edge of the module and extending between the bottom surface of the module and the bent end makes a side surface for containing the slipping sideways of the module in the opposite direction to that of the second element.

In the embodiment of FIG. 3 the second element is made simply with a pin or fixed tongue, the side surface of which (possibly rounded) makes a purely sliding surface along the guide channel.

FIG. 4 shows a second embodiment, in which the second element is in the form of a rolling element (generically indicated with 123, for example a wheel or a cylinder) that rotates around an axis perpendicular to the sliding surface of the belt. Advantageously, the rolling element is a ball bearing mounted on a pin 125 that projects from the bottom surface of the module. Such an embodiment has been found to be particularly advantageous because it allows the pulling force to be greatly reduced when the belt goes round particularly tight bends that tend to forcefully press the guide element against the side wall 24 of the guide surface. The pull is also reduced thanks to the lesser drag force. However, the anti-turnover means can also be those described with reference to FIG. 3.

Thanks to the special configuration of the guide means made according to the invention, an optimal guide is obtained both in bends and in rectilinear portions. In particular, in bends the anti-slip (against the radial pulling component) and anti-lifting functions are provided separately by the two elements 20 and 23.

Advantageously, as can be seen in the figures the guide elements can be made on sub-modules 11a of reduced width and greater strength (side area on the right in FIG. 1) and can be alternated with modules without guide means (as can be clearly seen, for example, in FIG. 5). The sub-modules with the two types of guide means can be made interchangeably, so as to be able to use one or the other or both without the need to change the configuration of the remaining sub-modules and of the belt.

In this way, it is possible to choose, for example, to use the guide means of FIG. 3 or 4 or no guide means or guide means spaced apart differently along the direction of travel of the belt, without needing to modify the other sub-modules and modules of the belt.

It is clear how combinations of the different sub-modules visible in the figures can allow various belt widths to be obtained, with or without guide means. In addition to make belts of different width it is thus possible to optimize the number of different pieces to be molded. This allows substantially cost-effective production and management of parts and of the belts.

At this point it is clear how the preset purposes have been achieved.

Of course, the description made above of an embodiment applying the innovative principles of the present invention is shown as an example of such innovative principles and therefore must not be taken to limit the scope of protection claimed here. For example, the proportions between the various elements, the width of the modules and of the belt can vary according to the specific requirements, just as the configuration of the top transportation surface of the belt can vary. Of course, modules can be made to have the guide means arranged in a mirroring fashion also near to the other edge of the belt, in the case in which a counteraction to turnover and a guide for bends both to the right and left are required. The belt can have the elements against sideways slipping and the elements against turnover arranged alternating on different sequential modules, as shown for example with a dashed line in FIG. 5.

1. A modular conveyor belt formed from modules that each comprise a body equipped on front and rear sides with hinging fingers spaced apart to define empty spaces between them that receive hinging fingers of subsequent modules of the belt, the fingers being equipped with slots for the passage of pins transversal to the conveying direction to couple together the successive modules so that they are hinged, guide means projecting from a bottom surface of the belt and near to a side edge thereof and intended to interact with guide elements present in a surface on which the belt is intended to run, characterized in that the guide means comprise a first anti-turnover element projecting from the bottom surface of the belt and intended to provide a holding component pointing substantially perpendicular to the plane of the belt and that opposes the turnover of the belt round a corner and a second anti-slip element projecting from the bottom surface of the belt in a more inner position than the first element and intended to provide a holding component substantially pointing parallel to the plane of the belt and that opposes the lateral slipping of the belt.

2. The belt according to claim 1, wherein the first element terminates with an end projecting towards the side edge of the belt to make an anti-turnover element of the belt intended to engage under surfaces of a sliding guide of the belt.

3. The belt according to claim 2, wherein the projecting end is bent in an L towards the side edge of the belt.

4. The belt according to claim 2, wherein the second projecting element, with a side surface thereof, makes a sliding element intended to rest against side surfaces of a sliding guide of the belt.

5. The belt according to claim 1, wherein the second projecting element comprises a rolling element that rotates around an axis that is perpendicular to a sliding surface of the belt.

6. The belt according to claim 5, wherein the rolling element is a bearing mounted on a pin projecting from the bottom surface of the belt.

7. The belt according to claim 2, wherein the side surface of the first element facing towards the edge of the belt and extending between the bottom surface of the belt and the projecting end makes a side surface for reducing the lateral slipping of the belt in the opposite direction to the second element.

8. The belt according to claim 1, wherein at least the slots of a side of each module are stretch in the conveying direction and in that the pitch of the fingers increases at least by areas from a first side edge of each module towards the opposite side edge, which is intended to constitute the inner edge in a tight bend.

9. The belt according to claim 1, wherein the length of the spaces in the conveying direction increases at least by areas from the first side edge towards the opposite side edge of the belt.

10. The belt according to claim 9, wherein the increase in length leads to the spaces passing over the middle of the modules.

11. The belt according to claim 1, wherein it is made up of sub-modules lined up in the direction transversal to the sliding direction of the belt.

12. The belt according to claim 11, wherein a side sub-module supports the guide means.

13. The belt according to claim 1, wherein modules equipped with guide means projecting beneath the belt are alternated, in the conveying direction of the belt, with modules without such guide means projecting below.

14. The belt according to claim 1, wherein the anti-turnover elements and anti-slip elements are arranged alternating on modules sequentially linked in the conveying direction of the belt.

15. The belt according to claim 1, wherein the first element comprises magnetic holding means to prevent turnover.

16. The modules equipped with anti-turnover and/or anti-slip means to make a curvilinear conveyor belt according to claim 1.
